(19) United States
(12) Patent Application Publication
(10) Pub. No.: US 2025/0047047 A1
(43) Pub. Date: Feb. 6, 2025

(54) COAXIAL CONNECTOR DEVICE AND METHOD OF MANUFACTURING COAXIAL CONNECTOR DEVICE

(71) Applicant: Japan Aviation Electronics Industry, Ltd., Tokyo (JP)

(72) Inventors: Takeharu NAITO, Tokyo (JP); Junji OOSAKA, Tokyo (JP); Ryou KATOU, Tokyo (JP); Kazuki ISHII, Tokyo (JP)

(21) Appl. No.: 18/791,631

(22) Filed: Aug. 1, 2024

(30) Foreign Application Priority Data
Aug. 2, 2023 (JP) 2023-126204

(51) Int. Cl. H01R 24/54; H01R 13/502; H01R 43/16; H01R 43/24

(52) U.S. Cl. CPC H01R 24/545; H01R 13/502; H01R 43/16; H01R 43/24

(57) ABSTRACT

Provided are a coaxial connector device and a method of manufacturing a coaxial connector device with enhanced impedance matching. A coaxial connector device is a coaxial connector device including a contact unit, the contact unit includes a contact and a housing that encloses a part of the contact, and the contact unit is formed by insert molding. The coaxial connector device may further include a die-cast member, the contact and the die-cast member may contain a conductor, the housing may contain an insulator, and a part of the housing extending in an axial direction may be disposed between a part of the contact extending in the axial direction and the die-cast member.

### INCORPORATION BY REFERENCE

This application is based upon and claims the benefit of priority from Japanese patent application No. 2023-126204, filed on Aug. 2, 2023, the disclosure of which is incorporated herein in its entirety by reference.

### BACKGROUND

The present disclosure relates to a coaxial connector device and a method of manufacturing a coaxial connector device.

Recent on-vehicle coaxial connector devices are required to transmit high-frequency signals. Accordingly, there is a demand for more effective adjustment of impedance matching in the design of a coaxial connector device that transmits high-frequency signals.

### SUMMARY

As shown in FIG. 17, a contact of a connector as disclosed in Japanese Unexamined Patent Application Publication No. 2022-189573, for example, is press-fit into a housing. Such an on-vehicle coaxial connector is generally designed in a structure where a contact is press-fit into a housing in order to optimize manufacturability. However, the structure where a contact is press-fit into a housing requires microscopic asperities on the surface of the contact in order to avoid the contact from coming out of the housing. Then, a high-frequency signal transmitted through the contact is affected by such asperities. This causes the on-vehicle coaxial connector to have difficulties in improving matching with design impedance.

The present disclosure has been accomplished to solve the above problem, and an object of the present disclosure is thus to provide a coaxial connector device and a method of manufacturing a coaxial connector device with improved impedance matching.

According to an aspect of the present disclosure, a coaxial connector device is a coaxial connector device including a contact unit, the contact unit includes a contact and a housing that encloses a part of the contact, and the contact unit is formed by insert molding.

The above-described coaxial connector device may further include a die-cast member, the contact and the die-cast member each may contain a conductor, the housing may contain an insulator, and a part extending in an axial direction in the housing may be disposed between a part of the contact extending in the axial direction and the die-cast member.

The above-described coaxial connector device may further include an external housing containing the insulator and a shielding shell containing the conductor, the external housing may include a first body part having a first penetrating hole and a first mating part, the die-cast member may include a second body part having a second penetrating hole configured to communicate with the first penetrating hole, and a second mating part configured to mate with the first mating part, and the shielding shell may include a third body part, a spring member having a spring shape, a cover part configured to cover the first mating part, and a fitting part formed at an end of the cover part and configured to be fit into a recess of the first mating part.

In the above-described coaxial connector device, the contact may include a distal end part projecting from the housing, and a middle-root part connected to the distal end part, wherein the housing has at least one hole where a part of the middle-root part is exposed.

In the above-described coaxial connector device, the housing may have a plurality of holes, and the plurality of holes may be formed with the contact interposed therebetween.

In the above-described coaxial connector device, the middle-root part may include a part having a square bar shape, and a part of each of opposed side surfaces may be exposed through the plurality of holes.

In the above-described coaxial connector device, the middle-root part may include a part having a round bar shape, and a part of each of opposed side surfaces may be exposed through the plurality of holes.

According to an aspect of the present disclosure, a method of manufacturing a coaxial connector device is a method of manufacturing a coaxial connector device for forming a contact unit including a contact and a housing that encloses a part of the contact by insert molding, the method comprising a step of preparing the contact; a step of enclosing a part of the contact with an encapsulant; and a step of curing the encapsulant and thereby forming the contact unit by insert molding.

In the above-described method of manufacturing a coaxial connector device, the step of preparing the contact may form the contact by bending a bar-shaped member containing a conductor.

In the above-described method of manufacturing a coaxial connector device, the step of preparing the contact may form the contact by cutting the contact out of a plate-shaped member containing a conductor.

In the above-described method of manufacturing a coaxial connector device, the step of enclosing a part of the contact with an encapsulant may expose a distal end part of the contact from the encapsulant, and enclose, with the encapsulant, a middle-root part connected to the distal end part and at least one holding member configured to come into contact with a part of the middle-root part so as to support the contact, the step of insert molding removes the holding member, so that the contact includes the distal end part projecting from the housing, and the middle-root part connected to the distal end part, and the housing has at least one hole from which a part of the middle-root part is exposed.

According to the present disclosure, there are provided a coaxial connector device and a method of manufacturing a coaxial connector device with improved impedance matching. The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view illustrating each member included in a coaxial connector device according to a comparative example;

FIG. 2 is a side view illustrating a contact in the coaxial connector device according to the comparative example;

FIG. 3 is an enlarged view illustrating a part of the contact in the coaxial connector device according to the comparative example;

FIG. 4 is a perspective view illustrating a part of the contact in the coaxial connector device according to the comparative example;

FIG. 5 is a sectional view illustrating an assembly of the coaxial connector device according to the comparative example;

FIG. 6 is a sectional view illustrating the coaxial connector device according to the comparative example, which shows a cross section along line VI-VI in FIG. 5;

FIG. 7 is an enlarged view illustrating a part of the coaxial connector device according to the comparative example, which shows a part VII in FIG. 6;

FIG. 8 is a perspective view illustrating each member included in a coaxial connector device according to a first embodiment;

FIG. 9 is a side view illustrating a contact unit in the coaxial connector device according to the first embodiment;

FIG. 10 is a sectional view illustrating the contact unit in the coaxial connector device according to the first embodiment, which shows a cross section along line X-X in FIG. 9; 5

FIG. 11 is a sectional view illustrating the contact unit in the coaxial connector device according to the first embodiment, which shows a cross section along line XI-XI in FIG. 9;

FIG. 12 is a side view illustrating a contact in the coaxial connector device according to the first embodiment;

FIG. 13 is a perspective view illustrating the contact in the coaxial connector device according to the first embodiment;

FIG. 14 is a flowchart illustrating a method of manufacturing a contact unit in a method of manufacturing a coaxial connector device according to the first embodiment;

FIG. 15 is a graph illustrating the impedance of the contact in the coaxial connector device according to the comparative example, where the horizontal axis indicates the position of the contact and the vertical axis indicates the impedance;

FIG. 16 is a graph illustrating the impedance of the contact in the coaxial connector device according to the first embodiment, where the horizontal axis indicates the position of the contact and the vertical axis indicates the impedance; and

FIG. 17 is a perspective view illustrating a contact and a housing of a connector according to related art.

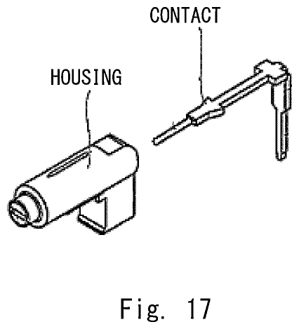

### DESCRIPTION OF EMBODIMENTS

A specific structure of the present disclosure will be described hereinbelow with reference to the drawings. The description provided hereinbelow merely illustrates preferred embodiments of the present disclosure, and the present disclosure is not limited to the below-described embodiments. In the following description, the identical reference symbols denote substantially identical elements. For clarity of the drawings, some reference symbols and hatching are omitted.

Prior to describing a coaxial connector device according to a first embodiment, a coaxial connector device according to a comparative example will be described for comparison. This will clarify the features of the coaxial connector device according to the first embodiment.

### Comparative Example

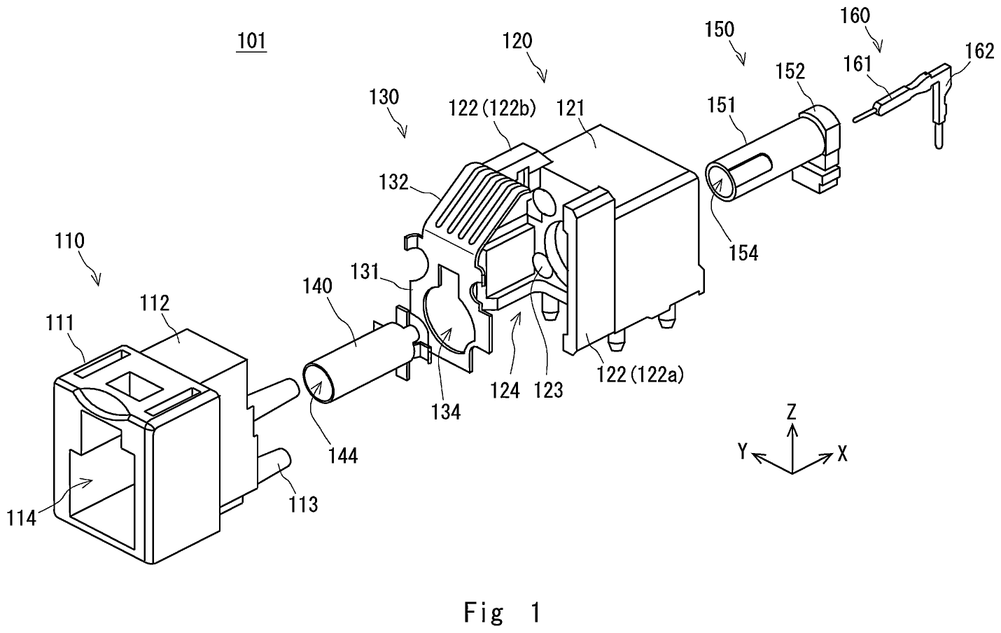

FIG. 1 is a perspective view illustrating each member included in a coaxial connector device 101 according to a comparative example. As shown in FIG. 1, the coaxial connector device 101 according to the comparative example includes an external housing 110, a die-cast member 120, a shielding shell 130, a GND shell member 140, an internal housing 150, and a contact 160.

For the convenience of description of the coaxial connector device 101 and a coaxial connector device 1, which is described later, the xyz-orthogonal coordinate axis system is used. For example, the axial direction of the coaxial connector device 101 or the like is referred to as x axis direction, and two directions orthogonal to the x axis are referred to as y axis direction and Z axis direction. In some cases, +Z axis direction is called upward, and a surface on the +Z axis direction side is called a top surface. Further, −Z axis direction is called downward, and a surface on the −z axis direction side is called an under surface. In some cases, +y axis direction and −y axis direction are called sideward, and a surface on the +y axis direction side and a surface on the −y axis direction side are called side surfaces. Note that upward, downward, top surface, down surface, sideward, and side surface are terms to be used for the convenience of description of the coaxial connector device 101 or the like, and they do not indicate the direction in which the coaxial connector device 101 or the like is disposed. Each structure is described hereinafter.

### External Housing

The external housing 110 has a tube shape. For example, the external housing 110 has a square tube shape. The external housing 110 includes a body part 111 and an insertion part 112. The body part 111 includes a part on the −x axis direction side of the external housing 110. The insertion part 112 includes a part on the +x axis direction side of the external housing 110. The width in the y axis direction and the width in the z axis direction of the body part 111 are greater than the width in the y axis direction and the width in the z axis direction of the insertion part 112. The insertion part 112 is configured to mate with a mating part 122 that is disposed on the −x axis direction side of the die-cast member 120. To be specific, the insertion part 112 is to be fit between a mating plate 122a and a mating plate 122b.

A projection 113 extending on the +x axis direction side is formed on an end surface of the insertion part 112 on the +x axis direction side. A plurality of projections 113 may be formed. The projection 113 is configured to be inserted into an insertion hole 123 in the die-cast member 120 when the insertion part 112 mates with the mating part 122 of the die-cast member 120.

The external housing 110 has a penetrating hole 114 that penetrates it from an end surface of the body part 111 on the −x axis direction side to an end surface of the insertion part 112 on the +x axis direction side. The penetrating hole 114 is disposed in such a way that its center axis is in the x axis direction. Members such as the GND shell member 140, the internal housing 150, and the contact 160 are to be inserted into the penetrating hole 114.

The external housing 110 contains an insulator as a material. For example, the external housing 110 contains a resin as a material. Note that the external housing 110 may contain an insulator other than a resin as long as it contains an insulator.

### Die-Cast Member

The die-cast member 120 includes the body part 121 and the mating part 122. The mating part 122 is connected to an end surface of the body part 121 on the −x axis direction side. The mating part 122 includes two plate-shaped mating plates 122a and 122b opposed to each other in the y axis direction. The mating plate 122a is disposed on the −y axis direction side in the end surface of the body part 121 on the −x axis direction side, and the mating plate 122b is disposed on the +y axis direction side in the end surface of the body part 121 on the −x axis direction side. The insertion part 112 of the external housing 110 is fit between the two mating plates 122a and 122b. To be specific, the insertion part 112 of the external housing 110 is fit between the two mating plates 122a and 122b with the shielding shell 130 interposed therebetween.

An insertion hole 123 is formed on the end surface of the body part 121 on the −x axis direction side. The same number of insertion holes 123 as the projections 113 may be formed. The insertion hole 123 is for the projection 113 of the external housing 110 to be inserted.

The die-cast member 120 has a penetrating hole 124 that penetrates it from an end surface of the body part 121 on the −x axis direction side to an end surface of the body part 121 on the +x axis direction side. The penetrating hole 124 is disposed in such a way that its center axis is in the x axis direction. The insertion hole 123 and the penetrating hole 124 are formed between parts where the mating plates 122a and 122b are connected in the end surface of the body part 121 on the −x axis direction side. Members such as the GND shell member 140, the internal housing 150, and the contact 160 are to be inserted into the penetrating hole 124.

The die-cast member 120 contains a conductor as a material. For example, the die-cast member 120 may include a metal such as aluminum and zinc as a material. The die-cast member 120 may be manufactured by die casting. Note that the die-cast member 120 is not limited to be manufactured by die casting, and it may include a member manufactured by another process such as casting or 3D printer or may include an external shell member equivalent of a die-cast. The die-cast member 120 is electrically connected to a ground (GND), together with the shielding shell 130. A connection structure for connecting to a specified board may be formed on the −z axis direction side of the die-cast member 120.

### Shielding Shell

The shielding shell 130 includes a plate-shaped part 131 in plate shape and a spring part 132 in spring shape. The plate-shaped part 131 has a plate surface on the +x axis direction side and a plate surface on the −x axis direction side. The plate-shaped part 131 has a penetrating hole 134 that penetrates the plate surface. The penetrating hole 134 is disposed in such a way that its center axis is in the x axis direction. The spring part 132 is connected to an end of the plate-shaped part 131 on the +z axis direction side. The spring part 132 has a plate shape, for example. The spring part 132 is disposed in such a way that its plate surface is inclined against the XY plane. The spring part 132 has spring elasticity. The spring part 132 can bend in the z axis direction.

The plate-shaped part 131 is disposed on the end surface of the body part 121 on the −x axis direction side in the die-cast member 120. Thus, the plate-shaped part 131 is disposed between the mating plate 122a and the mating plate 122b. The penetrating hole 134 in the plate-shaped part 131 is disposed to surround the penetrating hole 124. The insertion part 112 of the external housing 110 is disposed on the −x axis direction side of the plate-shaped part 131. The spring part 132 is disposed on a top surface of the body part 121 of the die-cast member 120.

The shielding shell 130 contains a conductor as a material. For example, the shielding shell 130 contains a metal as a material. The shielding shell 130 is electrically connected to the ground (GND), together with the die-cast member 120.

### GND Shell Member

The GND shell member 140 has a tube shape having a penetrating hole 144 that penetrates it in the x axis direction, for example. The penetrating hole 144 is disposed in such a way that its center axis is in the x axis direction. The GND shell member 140 has a cylindrical shape, for example. The GND shell member 140 is disposed inside the penetrating hole 114, the penetrating hole 134 and the penetrating hole 124 that communicate as the external housing 110, the plate-shaped part 131 and the die-cast member 120 are placed on top of one another in the x axis direction. The internal housing 150 into which the contact 160 is press-fit is to be inserted into the GND shell member 140.

The GND shell member 140 contains a conductor as a material. For example, the GND shell member 140 contains a metal as a material. The GND shell member 140 is electrically connected to the ground (GND), together with the die-cast member 120 and the shielding shell 130.

### Internal Housing

The internal housing 150 includes a tubular part 151 and a support part 152. The tubular part 151 has a cylindrical shape, for example. Note that the tubular part 151 is not limited to be cylindrical as long as it is tubular. The tubular part 151 is disposed in such a way that its center axis is in the x axis direction. The tubular part 151 has a penetrating hole 154 that penetrates it from an end on the +x axis direction side to an end on the −x axis direction side. Thus, the penetrating hole 154 is disposed in such a way that its center axis is in the x axis direction.

The support part 152 is connected to the +x axis direction side of the tubular part 151. The support part 152 is in plate shape extending in the z axis direction, which has plate surfaces facing the +x axis direction side and the −x axis direction side. The tubular part 151 is connected to an end on the +z axis direction side in the plate surface of the support part 152 on the −x axis direction side. Thus, when viewed from the y axis direction, the internal housing 150 is L-shaped. The support part 152 has, at an end on the +z axis direction side, a penetrating hole 154 that penetrates it from the plate surface on the +x axis direction side to the plate surface on the −x axis direction side. The penetrating hole 154 of the support part 152 communicates with the penetrating hole 154 of the tubular part 151. The contact 160 is to be press-fit into the communicating penetrating hole 154. Further, a groove with which the contact 160 is to mate may be formed on the plate surface of the support part 152 on the +x axis direction side. The groove extends from the penetrating hole 154 to the −z axis direction side on the plate surface of the support part 152 on the +x axis direction side.

The internal housing 150 contains an insulator as a material. For example, the internal housing 150 contains a resin as a material. Note that the internal housing 150 may contain an insulator other than a resin as long as it contains an insulator.

### Contact

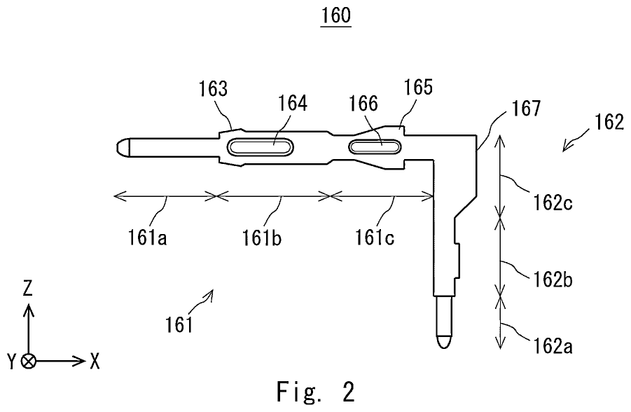

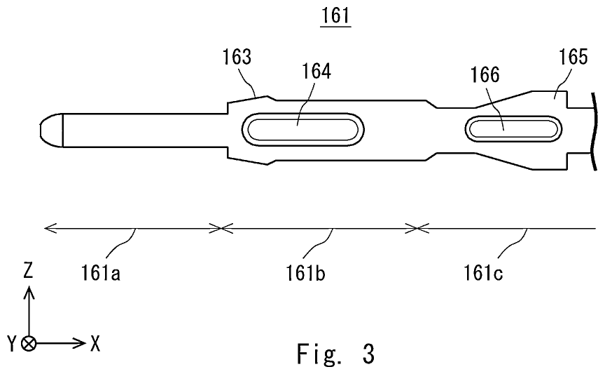

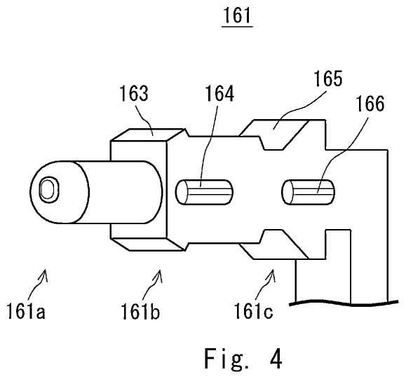

FIG. 2 is a side view illustrating the contact 160 in the coaxial connector device 101 according to the comparative example. FIG. 3 is an enlarged view illustrating a part of the contact 160 in the coaxial connector device 101 according to the comparative example. FIG. 4 is a perspective view illustrating a part of the contact 160 in the coaxial connector device 101 according to the comparative example;

As shown in FIGS. 2 to 4, the contact 160 is in L shape having a part extending in the x axis direction and a part extending in the z axis direction. The part extending in the x axis direction is referred to as a first bar-shaped part 161, and the part extending in the z axis direction is referred to as a second bar-shaped part 162. An end of the first bar-shaped part 161 on the +x axis direction side is connected to an end of the second bar-shaped part 162 on the +z axis direction side. Although the first bar-shaped part 161 and the second bar-shaped part 162 of the contact 160 are orthogonal to each other, it is not limited thereto, and they may intersect at angles other than 90°. Note that being orthogonal is not limited to intersecting strictly at 90°, and it includes intersecting at 90° in a range containing an unavoidable error such as an error of measurement.

The first bar-shaped part 161 includes a distal end part 161a, a middle part 161b, and a root part 161c, for example. The distal end part 161a has a round bar shape. A distal end of the distal end part 161a is rounded in hemispherical shape. The middle part 161b has a square bar shape. The width between opposed side surfaces of the middle part 161b in square bar shape is greater than the outside diameter of the distal end part 161a in round bar shape. The middle part 161b has a projection 163 on the −x axis direction side of each of its side surfaces on the +z axis direction side and the −z axis direction side. The middle part 161b has a projection 164 on each of its side surfaces on the +y axis direction side and the −y axis direction side.

The root part 161c has a square bar shape. The width between opposed side surfaces of the square bar-shaped root part 161c is greater than the outside diameter of the round bar-shaped distal end part 161a. The root part 161c has a projection 165 on each of its side surfaces on the +z axis direction side and the −z axis direction side. The projection 165 is inclined in such a way that the width in the z axis direction increases toward the +x axis direction side. The root part 161c has a projection 166 on each of its side surfaces on the +y axis direction side and the −y axis direction side.

The first bar-shaped part 161 in the contact 160 is press-fit into the penetrating hole 154 of the internal housing 150. Such a press-fitting process of a contact requires the projections 163 to 166 for retention in press-fitting. The projection 164 and the projection 166 on the side surfaces on the +y axis direction side and the −y axis direction side are also referred to as dowel parts. The contact 160 may be formed by die-cutting of a metal plate into L-shape. Thus, the y axis direction of the contact 160 is referred to also as a thickness direction. Therefore, the contact 160 requires dowel parts in the thickness direction for retention in the internal housing 150 after press-fitting.

The second bar-shaped part 162 includes a distal end part 162a, a middle part 162b, and a root part 162c, for example. The distal end part 162a has a round bar shape. A distal end of the distal end part 162a is rounded in hemispherical shape. The distal end part 162a is connected to a specified board that is disposed on the −z axis direction side. The middle part 162b has a square bar shape. The width between opposed side surfaces of the middle part 162b in square bar shape is greater than the outside diameter of the distal end part 162a in round bar shape. The root part 162c has a square bar shape. The root part 162c has, on its side surface on the +x axis direction side, a pushing part 167 for pushing the contact 160 when press-fitting the contact 160 into the internal housing 150.

The contact 160 contains a conductor as a material. For example, the contact 160 contains a metal as a material. The contact 160 serves as a transmission path of a high-frequency signal. The distal end part 161a of the first bar-shaped part 161 in the contact 160 serves as a connection part to another connector, and the distal end part 162a of the second bar-shaped part 162 is connected to a board connection part.

### Method of Assembly

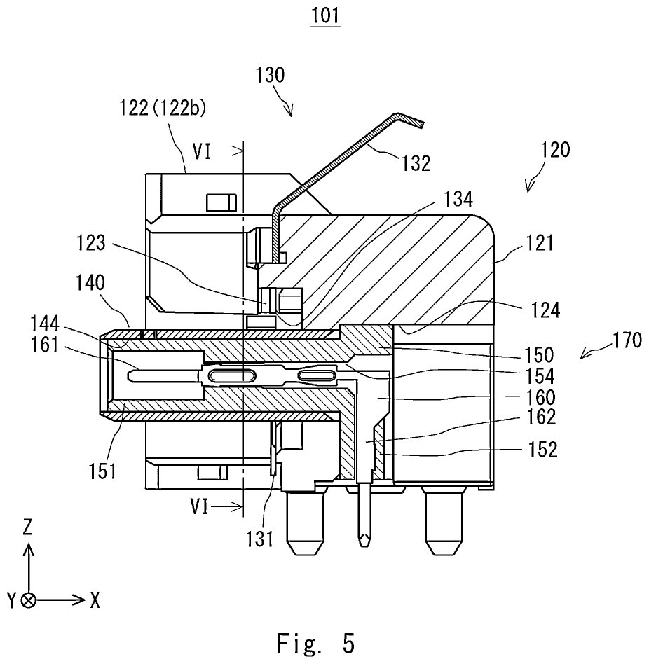

FIG. 5 is a sectional view illustrating an assembly of the coaxial connector device 101 according to the comparative example. Note that the external housing 110 is omitted in FIG. 5. As shown in FIG. 5, the first bar-shaped part 161 of the contact 160 is press-fit into the penetrating hole 154 of the internal housing 150 in the −x axis direction. In this process, the side surface of the middle part 162b and the root part 162c on the −x axis direction side of the second bar-shaped part 162 of the contact 160 mates with the groove of the support part 152 of the internal housing 150. The internal housing 150 into which the contact 160 is press-fit is referred to as a contact unit 170. Thus, the contact unit 170 includes the contact 160 and the internal housing 150.

The contact unit 170 is press-fit into the penetrating hole 144 of the GND shell member 140. The GND shell member 140 is inserted into the penetrating hole 124 of the die-cast member 120 and the penetrating hole 134 of the shielding shell 130 in the −x axis direction.

The insertion part 112 of the external housing 110 is fit between the two mating plates 122a and 122b of the die-cast member 120 with the shielding shell 130 interposed therebetween. In this process, the projection 113 of the external housing 110 is inserted into the insertion hole 123 of the die-cast member 120. The GND shell member 140 that contains the internal housing 150 and the contact 160 are inserted into the penetrating hole 114 of the external housing 110.

### Problem in Comparative Example

It is important to improve the transmission characteristics of high-frequency signals in the coaxial connector device 101. As described in the coaxial connector device 101 according to the comparative example, a process of press-fitting the contact 160 into the penetrating hole 154 of the internal housing 150 requires the contact 160 to have the projections 163 to 166 and the pushing part 167. However, the projections 163 to 166 and the pushing part 167 degrade the transmission characteristics of high-frequency signals. This causes the coaxial connector device 101 to have difficulty in improving the impedance matching. In order to improve the impedance matching, there is a demand for a method for retaining the contact 160 in the internal housing 150 without the projections 163 to 166 and the pushing part 167.

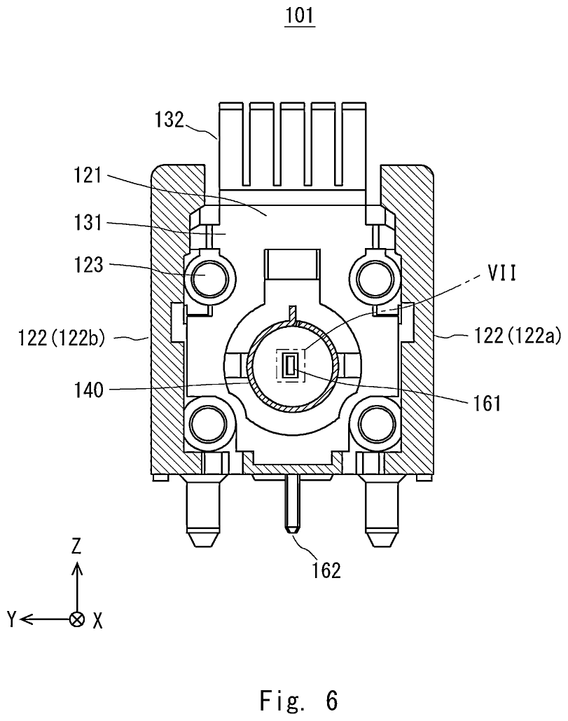

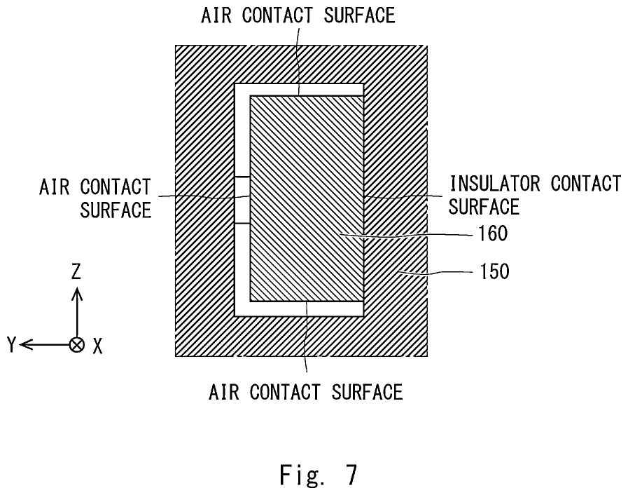

FIG. 6 is a sectional view illustrating the coaxial connector device 101 according to the comparative example, which shows a cross section along line VI-VI in FIG. 5. FIG. 7 is an enlarged view illustrating a part of the coaxial connector device 101 according to the comparative example, which shows a part VII in FIG. 6. As shown in FIGS. 6 and 7, an insulator of the internal housing 150 or the like and an airspace exist around the contact 160. Thus, the contact 160 includes a part in contact with an insulator and a part in contact with a metal. Since the dielectric constant of a part in contact with the contact 160 differs from each other, it is necessary to adjust the size of a part in contact with an insulator and a part in contact with a metal in order to match the impedance of the contact 160 with design impedance.

For example, in the contact 160, the impedance of a part in contact with an insulator decreases. Thus, when the impedance of the contact 160 is low, the width of the contact 160 in the z axis direction is narrowed to make the part in contact with an insulator smaller. The impedance of the contact 160 thereby increases. On the other hand, the impedance of a part in contact with an airspace increases. Thus, when the impedance of the contact 160 is high, the width of the contact 160 in the z axis direction is enlarged to make the part in contact with an insulator larger. The impedance of the contact 160 thereby decreases.

In this manner, a member in contact with the contact 160 varies due to manufacturing variations, and the impedance varies accordingly. It is desirable to easily adjust the impedance matching of the contact 160 even in such a case.

### First Embodiment

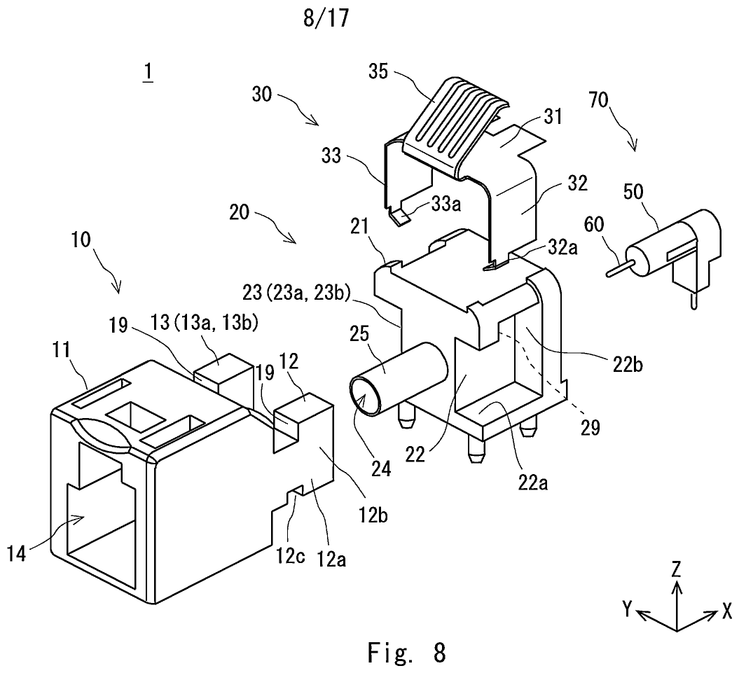

A coaxial connector device according to a first embodiment will be described hereinafter. FIG. 8 is a perspective view illustrating each member included in a coaxial connector device 1 according to the first embodiment. As shown in FIG. 8, the coaxial connector device 1 according to this embodiment includes an external housing 10, a die-cast member 20, a shielding shell 30, and a contact unit 70.

### External Housing

The external housing 10 has a tube shape. For example, the external housing 10 has a square tube shape. The external housing 10 includes a body part 11 and L-shaped parts 12 and 13. The L-shaped parts 12 and 13 are connected an end surface of the body part 11 on the +x axis direction side. The L-shaped parts 12 and 13 function as a mating part configured to mate with the die-cast member 20.

The body part 11 has a penetrating hole 14 that penetrates it from an end surface on the −x axis direction side to an end surface on the +x axis direction side. Thus, the external housing 10 has the penetrating hole 14 that penetrates it in the x axis direction. Members such as a cylindrical part 25 of the die-cast member 20 and the contact unit 70 are to be inserted into the penetrating hole 14. The L-shaped parts 12 and 13 are disposed in parallel in the y axis direction on the end surface of the body part 11 on the +x axis direction side. The L-shaped parts 12 and 13 are disposed at both ends of the penetrating hole 14 in the y axis direction in the end surface of the body part 11 on the +x axis direction side.

The L-shaped part 12 includes a first extension part 12a and a second extension part 12b. The first extension part 12a extends in the +x axis direction from the end surface of the body part 11 on the +x axis direction side. The second extension part 12b extends in the +z axis direction from an end of the first extension part 12a on the +x axis direction side. A recess 12c is formed at an end of the first extension part 12a on the −z axis direction side in the L-shaped part 12.

The L-shaped part 13 includes a first extension part 13a and a second extension part 13b. The first extension part 13a extends in the +x axis direction from the end surface of the body part 11 on the +x axis direction side. The second extension part 13b extends in the +z axis direction from an end of the first extension part 13a on the +x axis direction side. A recess 13c is formed at an end of the first extension part 13a on the −z axis direction side in the L-shaped part 13. The L-shaped parts 12 and 13 are L-shaped when viewed from the y axis direction.

The L-shaped part 12 is to be inserted into an L-shaped groove 22 formed on a side surface of the die-cast member 20 on the −y axis direction side. The recess 12c is to be fit with a fitting part 32a of the shielding shell 30. The L-shaped part 13 is to be inserted into an L-shaped groove 23 formed on a side surface of the die-cast member 20 on the +y axis direction side. The recess 13c is to be fit with a fitting part 33a of the shielding shell 30.

The “L” shape of the L-shaped parts 12 and 13 may be reversed in the z axis direction. Specifically, the second extension part 12b may extend in the −z axis direction from the end of the first extension part 12a on the +x axis direction side. Further, the second extension part 13b may extend in the −z axis direction from the end of the first extension part 13a on the +x axis direction side. In this case, the structures of the L-shaped grooves 22 and 23 of the die-cast member 20 may be reversed in the z axis direction in accordance with the “L” shape of the L-shaped parts 12 and 13. However, when the above-described specified board is connected to the −z axis direction side, the second extension parts 12b and 13b preferably extend on the +z axis direction side, which is opposite to the direction in which the specified board is connected. As the second extension parts 12b and 13b extend on the +z axis direction side, they can cope with a force in the −z axis direction in which the specified board is connected.

Further, both of the L-shaped parts 12 and 13 are not necessarily formed, and only one of them may be formed. Specifically, the L-shaped part 12 or the like may be disposed on at least any one of the −y axis direction side and the +y axis direction side in the end surface of a body part 21 of the die-cast member 20 on the −x axis direction side. Further, depending on the orientation of the L-shaped grooves 22 and 23 of the die-cast member 20, the direction in which the second extension parts 12b and 13b extend is not limited to the z axis direction, and they may extend in the y axis direction or in the direction tiled in the y axis direction and the z axis direction.

The external housing 10 contains an insulator as a material. For example, the external housing 10 contains a resin as a material. Note that the external housing 10 may contain an insulator other than a resin as long as it contains an insulator.

### Die-Cast Member

The die-cast member 20 includes the body part 21 and the cylindrical part 25. The cylindrical part 25 is connected to an end surface of the body part 21 on the −x axis direction side. The cylindrical part 25 has a cylindrical shape. The body part 21 has a penetrating hole 24 that penetrates it from an end surface on the +x axis direction side to an end surface on the −x axis direction side. The penetrating hole 24 communicates with the cylindrical part 25. Thus, the die-cast member 20 has the penetrating hole 24 that penetrates it from the end surface of the body part 21 on the +x axis direction side to the end surface of the cylindrical part 25 on the −x axis direction side. The penetrating hole 24 is disposed in such a way that its center axis is in the x axis direction. The penetrating hole 24 may communicate with the penetrating hole 14 of the external housing 10. A member such as the contact unit 70 is to be inserted into the penetrating hole 24.

The L-shaped grooves 22 and 23 are formed in the body part 21. Thus, the die-cast member 20 includes the body part 21 and the L-shaped grooves 22 and 23. The L-shaped grooves 22 and 23 function as a mating part configured to mate with the external housing 10.

The L-shaped groove 22 is formed on a side surface of the body part 21 on the −y axis direction side. The L-shaped groove 22 includes a first groove part 22a and a second groove part 22b. The first groove part 22a extends in the +x axis direction from the end surface of the body part 21 on the −x axis direction side. The second groove part 22b extends in the +z axis direction from the end of the first groove part 22a on the +x axis direction side. Thus, the L-shaped groove 22 is L-shaped when viewed from the y axis direction. A part of the body part 21 remains on the −x axis direction side of the second groove part 22b.

The L-shaped groove 23 is formed on a side surface of the body part 21 on the +y axis direction side. The L-shaped groove 23 includes a first groove part 23a and a second groove part 23b. The first groove part 23a extends in the +x axis direction from the end surface of the body part 21 on the −x axis direction side. The second groove part 23b extends in the +z axis direction from the end of the first groove part 23a on the +x axis direction side. Thus, the L-shaped groove 23 is L-shaped when viewed from the y axis direction. A part of the body part 21 remains on the −x axis direction side of the second groove part 23b.

Note that when the “L” shape of the L-shaped parts 12 and 13 is reversed in the z axis direction as described above, the structures of the L-shaped grooves 22 and 23 may be reversed in the z axis direction in accordance with the “L” shape of the L-shaped parts 12 and 13. Specifically, the second groove part 22b may extend in the −z axis direction from the end of the first groove part 22a on the +x axis direction side. Further, the second groove part 23b may extend in the −z axis direction from the end of the first groove part 23a on the +x axis direction side.

Further, both of the L-shaped grooves 22 and 23 are not necessarily formed, and only one of them may be formed. Specifically, the L-shaped groove 22 or the like may be formed on at least any one of the −y axis direction side and the +y axis direction side in the body part 21 of the die-cast member 20. Further, depending on the orientation of the L-shaped parts 12 and 13 of the external housing 10, the direction in which the second groove parts 22b and 23b extend is not limited to the z axis direction, and they may extend in the y axis direction or in the direction tiled in the y axis direction and the z axis direction.

In the coaxial connector device 1, the external housing 10 and the die-cast member 20 touch and connect each other in the x axis direction parallel to the axial direction. First, the second extension part 12b of the L-shaped part 12 of the external housing 10 is inserted in the +x axis direction into the first groove part 22a of the L-shaped groove 22. Further, the second extension part 13b of the L-shaped part 13 of the external housing 10 is inserted in the +x axis direction into the first groove part 23a of the L-shaped groove 23.

Then, after the second extension part 12b is inserted in the +x axis direction into the first groove part 22a, the second extension part 12b is inserted in the +z axis direction along the second groove part 22b of the L-shaped groove 22. Likewise, after the second extension part 13b of the L-shaped part 13 of the external housing 10 is inserted in the +x axis direction into the first groove part 23a of the L-shaped groove 23, it is inserted in the +z axis direction along the second groove part 23b of the L-shaped groove 23.

In this manner, the L-shaped part 12 of the external housing 10 is formed in such a way that the L-shaped part 12 is inserted into the L-shaped groove 22 of the die-cast member 20. Further, the L-shaped part 13 of the external housing 10 is formed in such a way that the L-shaped part 13 is inserted into the L-shaped groove 23 of the die-cast member 20.

When the L-shaped part 12 of the external housing 10 is inserted into the L-shaped groove 22 of the die-cast member 20, a surface 19 of the second extension part 12b on the −x axis direction side in the L-shaped part 12 comes into contact with a surface 29 of the second groove part 22b facing the +x axis direction in the L-shaped groove 22. When the L-shaped part 13 of the external housing 10 is inserted into the L-shaped groove 23 of the die-cast member 20, a surface 19 of the second extension part 13b on the −x axis direction side in the L-shaped part 13 comes into contact with a surface 29 of the second groove part 23b facing the +x axis direction in the L-shaped groove 23. In other words, the surface 29 on the +x axis direction side in a part of the body part 21 located on the −x axis direction side of the second groove parts 22b and 23b comes into contact with the surface 19 of the second extension parts 12b and 13b on the −x axis direction side.

The die-cast member 20 contains a conductor as a material. For example, the die-cast member 20 may include a metal such as aluminum and zinc as a material. The die-cast member 20 may be manufactured by die casting. Note that the die-cast member 20 is not limited to be manufactured by die casting, and it may include a member manufactured by another process such as casting or 3D printer or may include an external shell member equivalent of a die-cast. The die-cast member 20 is electrically connected to a ground (GND), together with the shielding shell 30.

### Shielding Shell

The shielding shell 30 includes a body part 31, cover parts 32 and 33, fitting parts 32a and 33a, and a spring member 35. The body part 31 has a plate surface on the +z axis direction side and a plate surface on the −z axis direction side. The body part 31 is disposed on a top surface of the die-cast member 20 on the +z axis direction side. The spring member 35 is connected to an end of the body part 31 on the −x axis direction side. The spring member 35 has a plate shape, for example. The spring member 35 is disposed in such a way that its plate surface is inclined against the body part 31. The spring member 35 has spring elasticity. The spring member 35 can thereby bend in the z axis direction.

Each of the cover parts 32 and 33 is in plate shape and has a plate surface on the +y axis direction side and a plate surface on the −y axis direction side. Ends of the cover parts 32 and 33 on the +z axis direction side are respectively connected to both ends of the body part 31 in the y axis direction. The cover part 32 extends in the −z axis direction from the end of the body part 31 on the −y axis direction side in the y axis direction. The cover part 32 covers the L-shaped part 12 in the y axis direction. The fitting part 32a is at the end of the cover part 32 on the −z axis direction side. The fitting part 32a is fit into the recess 12c of the L-shaped part 12. For example, the fitting part 32a is curved on the +y axis direction side to fit into the recess 12c. The fitting part 32a thereby fixes the L-shaped part 12 of the external housing 10.

The cover part 33 extends in the −z axis direction from the end of the body part 31 on the +y axis direction side in the y axis direction. The cover part 33 covers the L-shaped part 13 in the y axis direction. The fitting part 33a is at the end of the cover part 33 on the −z axis direction side. The fitting part 33a is fit into the recess 13c of the L-shaped part 13. For example, the fitting part 33a is curved on the −y axis direction side to fit into the recess 13c. The fitting part 33a thereby fixes the L-shaped part 13 of the external housing 10.

Note that both of the cover parts 32 and 33 are not necessarily formed, and only one of them may be formed. Specifically, the cover part 32 or the like may extend in the −z axis direction from at least any one of the end on the −y axis direction side and the end on the +y axis direction side of the body part 31.

The shielding shell 30 contains a conductor as a material. For example, the shielding shell 30 contains a metal as a material. The shielding shell 30 is electrically connected to the ground (GND), together with the die-cast member 20.

### Contact Unit

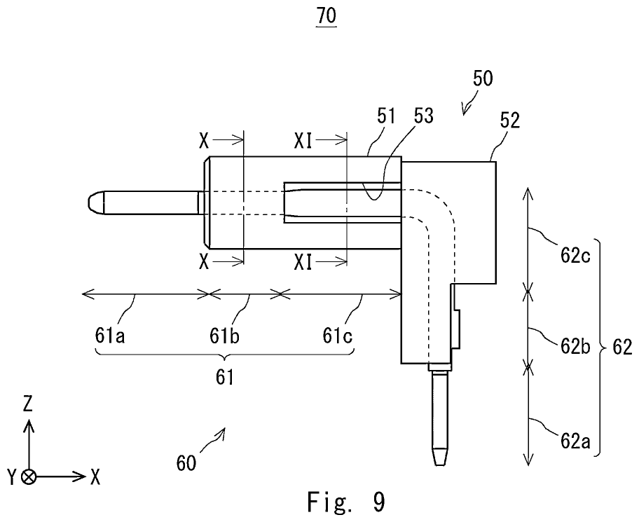

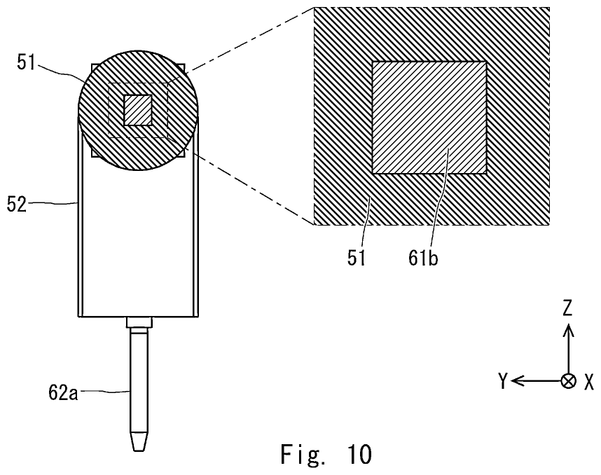

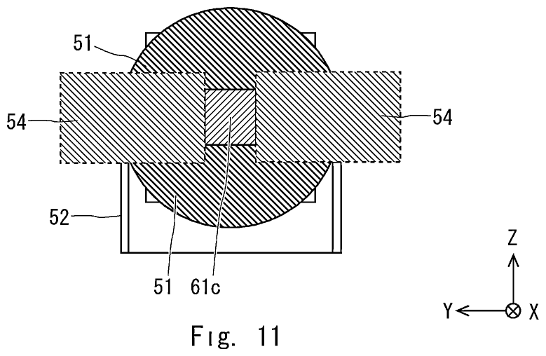

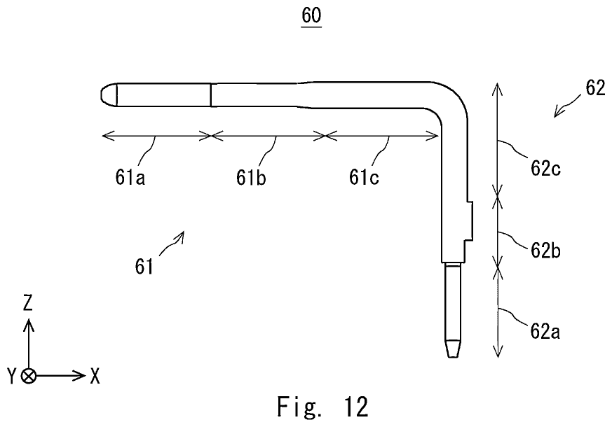

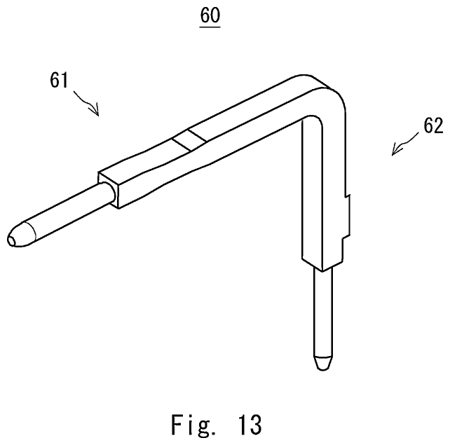

FIG. 9 is a side view illustrating a contact unit 70 in the coaxial connector device 1 according to the first embodiment. FIG. 10 is a sectional view illustrating the contact unit 70 in the coaxial connector device 1 according to the first embodiment, which shows a cross section along line X-X in FIG. 9. FIG. 11 is a sectional view illustrating the contact unit 70 in the coaxial connector device 1 according to the first embodiment, which shows a cross section along line XI-XI in FIG. 9. FIG. 12 is a side view illustrating a contact 60 in the coaxial connector device 1 according to the first embodiment. FIG. 13 is a perspective view illustrating the contact 60 in the coaxial connector device 1 according to the first embodiment.

As shown in FIGS. 9 to 13, the contact unit 70 includes a housing 50 and the contact 60. The contact unit 70 is formed by insert molding. Specifically, the contact 60 and the housing 50 are integrated into the contact unit 70 by insert molding. Note that the contact unit 70 may be formed by press-fitting the contact 60 into the housing 50 in the −x axis direction.

The contact 60 is in L shape having a part extending in the x axis direction and a part extending in the z axis direction. The part extending in the x axis direction is referred to as a first bar-shaped part 61, and the part extending in the z axis direction is referred to as a second bar-shaped part 62. An end of the first bar-shaped part 61 on the +x axis direction side is connected to an end of the second bar-shaped part 62 on the +z axis direction side. Although the first bar-shaped part 61 and the second bar-shaped part 62 of the contact 60 are orthogonal to each other, it is not limited thereto, and they may intersect at angles other than 90°. Note that being orthogonal is not limited to intersecting strictly at 90°, and it includes intersecting at 90° in a range containing an unavoidable error such as an error of measurement.

The first bar-shaped part 61 includes a distal end part 61a, a middle part 61b, and a root part 61c, for example. The distal end part 61a has a round bar shape. A distal end of the distal end part 61a is rounded in hemispherical shape. The middle part 61b and the root part 61c have a square bar shape. Thus, the first bar-shaped part 61 includes a part in square bar shape. The middle part 61b and the root part 61c are collectively referred to as a middle-root part in some cases. The middle-root part is connected to the distal end part 61a. The width between opposed side surfaces of the middle part 61b and the root part 61c in square bar shape is greater than the outside diameter of the distal end part 61a in round bar shape. No projection is formed on the side surfaces of the middle part 61b and the root part 61c, unlike the contact 160 according to the comparative example. Note that the middle part 61b and the root part 61c may have a round bar shape. Specifically, the first bar-shaped part 61 may include a part in round bar shape.

A part of the first bar-shaped part 61 in the contact 60 is incorporated into the housing 50 by insert molding. To be specific, for example, the middle-root part in the first bar-shaped part 61 is incorporated into the housing 50. On the other hand, the distal end part 61a in the first bar-shaped part 61 projects from the end surface of a tubular part 51 on the −x axis direction side in the housing 50.

The second bar-shaped part 62 includes a distal end part 62a, a middle part 62b, and a root part 62c, for example. The distal end part 62a has a round bar shape. A distal end of the distal end part 62a is rounded in hemispherical shape. The middle part 62b and the root part 62c have a square bar shape. Thus, the second bar-shaped part 62 includes a part in square bar shape. The middle part 62b and the root part 62c are collectively referred to as a middle-root part in some cases. The middle-root part is connected to the distal end part 62a. The width between opposed side surfaces of the middle part 62b and the root part 62c in square bar shape is greater than the outside diameter of the distal end part 62a in round bar shape. A projection may be formed on a side surface of the middle part 62b on the +x axis direction side.

In this manner, the contact 60 includes the distal end part 61a that projects from the housing 50 and the middle-root part that is connected to the distal end part 61a. Further, the contact 60 includes the distal end part 62a that projects from the housing 50 and the middle-root part that is connected to the distal end part 62a. At least part of the middle-root part is incorporated into the housing 50.

The contact 60 contains a conductor as a material. For example, the contact 60 contains a metal as a material. The contact 60 serves as a transmission path of a high-frequency signal. The distal end part 61a of the first bar-shaped part 61 in the contact 60 serves as a connection part to another connector, and the distal end part 62a of the second bar-shaped part 62 is connected to a board connection part.

The housing 50 includes a tubular part 51 and a support part 52. The tubular part 51 has a cylindrical shape, for example. Note that the tubular part 51 is not limited to be cylindrical as long as it is tubular. The tubular part 51 is disposed in such a way that its center axis is in the x axis direction. The tubular part 51 in the housing 50 encloses a part of the contact 60. The housing 50 thereby incorporates a part of the contact 60. To be specific, the tubular part 51 incorporates the middle part 61b and the root part 61c of the first bar-shaped part 61 of the contact 60.

The tubular part 51 has a hole 53 on its side surface. Note that the support part 52 may have the hole 53. A part of the contact 60 is exposed through the hole 53. A part of the contact 60 may come into contact with air through the hole 53. In this manner, the housing 50 has at least one hole 53 through which a part of the contact 60 is exposed. For example, the housing 50 has at least one hole 53 through which a part of the middle-root part is exposed. The hole 53 is formed sideward of the tubular part 51 in the y axis direction, for example.

The housing 50 may have a plurality of holes 53. The plurality of holes 53 may be formed with the contact 60 interposed therebetween. For example, the plurality of holes 53 may be opposed to each other with the center axis of the contact 60 interposed therebetween. The coaxial connector device 1 thereby allows uniformizing the impedance of parts between which the contact 60 is interposed. It also allows uniformizing the impedance of parts opposed to each other with the center axis of the contact 60 interposed therebetween. For example, when the middle-root part of the first bar-shaped part 61 includes a part in square bar shape, a part of opposed flat side surfaces is exposed through the plurality of holes 53. When the middle-root part of the first bar-shaped part 61 includes a part in round bar shape, a part of opposed curved side surfaces may be exposed through the plurality of holes 53.

The plurality of holes 53 may be one pair of holes that are opposed to each other with the center axis of the contact 60 interposed therebetween, or may be a plurality of pairs of holes that are opposed to each other with the center axis of the contact 60 interposed therebetween. The plurality of holes 53 may be formed in a discrete manner around the center axis. The plurality of holes 53 are formed by using a holding member 54 that supports the contact 60 during insert molding as described later.

The support part 52 is connected to the +x axis direction side of the tubular part 51. The support part 52 is in plate shape extending in the z axis direction, which has plate surfaces on the +x axis direction side and the −x axis direction side. The tubular part 51 is connected to the +z axis direction side in the plate surface of the support part 52 on the −x axis direction side. Thus, when viewed from the y axis direction, the housing 50 is L-shaped.

The housing 50 contains an insulator as a material. For example, the housing 50 contains a resin as a material. Note that the housing 50 may contain an insulator other than a resin as long as it contains an insulator.

### Method of Manufacture

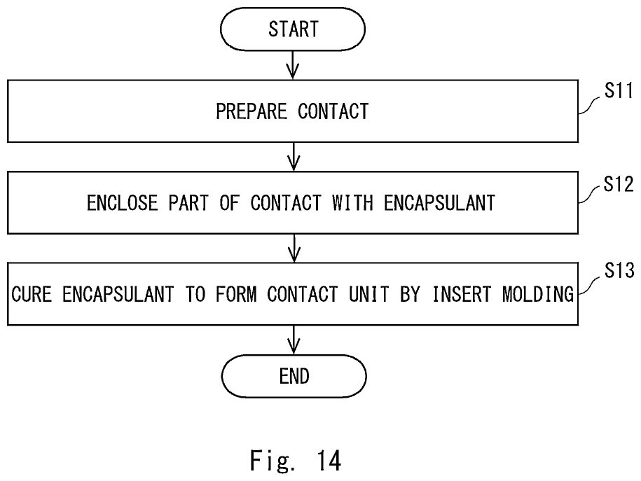

A method of manufacturing the coaxial connector device 1, including a method of manufacturing the contact unit 70, is described next. A method of manufacturing the coaxial connector device according to this embodiment forms the contact unit 70 including the contact 60 and the housing 50 that encloses a part of the contact 60 by insert molding. FIG. 14 is a flowchart illustrating a method of manufacturing the contact unit 70 in the method of manufacturing the coaxial connector device 1 according to the first embodiment. As shown in FIG. 14, the method of manufacturing the coaxial connector device 1 includes a step S11 of preparing the contact 60, a step S12 of enclosing a part of the contact 60 with an encapsulant, and a step S13 of curing the encapsulant and thereby forming the contact unit 70 by insert molding.

The step S11 of preparing the contact 60 may form the contact 60 by bending a bar-shaped member containing a conductor. Further, the step S11 of preparing the contact 60 may form the contact 60 by cutting it out from a plate-shaped member containing a conductor.

The step S12 of enclosing a part of the contact 60 with an encapsulant exposes the distal end part 61a of the contact 60 from the encapsulant. Further, this step encloses, with an encapsulant, a middle-root part connected to the distal end part 61a and at least one holding member 54 that comes into contact with a part of the middle-root part and supports the contact 60.

Then, the step S13 of curing the encapsulant and thereby forming the contact unit 70 by insert molding removes the holding member 54. As a result, the contact 60 includes the distal end part 61a projecting from the housing 50 and the middle-root part connected to the distal end part 61a. Further, the housing 50 has at least one hole 53 where a part of the middle-root part is exposed.

### Method of Assembly

The contact unit 70 is inserted into the penetrating hole 24 of the die-cast member 20 in the −x axis direction. The tubular part 51 extending in the x axis direction in the housing 50 is disposed between the first bar-shaped part 61 extending in the x axis direction in the contact 60 and the die-cast member 20. The L-shaped parts 12 and 13 of the external housing 10 mate with the L-shaped grooves 22 and 23 of the die-cast member 20. The cover parts 32 and 33 cover the L-shaped parts 12 and 13 from sideward, respectively. The recesses 12c and 13c are fit with the fitting parts 32a and 33a, respectively. A member such as the contact unit 70 is inserted into the penetrating hole 14 of the external housing 10 and the penetrating hole 24 of the die-cast member 20.

An advantageous effect of this embodiment is described hereinafter. In the coaxial connector device 1 according to this embodiment, the contact 60 and the housing 50 are integrated into contact unit 70 by insert molding. Thus, the coaxial connector device 1 does not have a press-fit structure that is used in the coaxial connector device 101 according to the comparative example. Therefore, the coaxial connector device 1 does not need the projections 163 to 166 of the contact 160, so that the transmission characteristics of high-frequency signals are improved. Specifically, by adopting insert molding, the need for microscopic asperities of the contact 60 is eliminated, which facilitates the adjustment of impedance. This allows improving the impedance matching.

Further, by providing at least one holding member 54 of the contact 60 in insert molding, the hole 53 (by the holding member 54) is provided at a position where the impedance decreases inside an insulator. This also facilitates the adjustment of impedance.

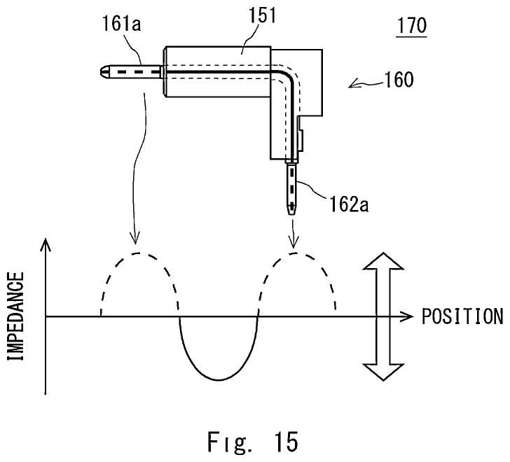

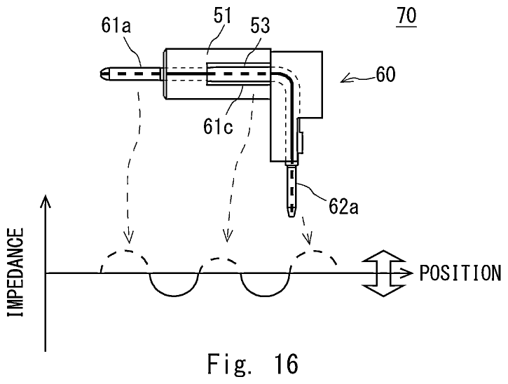

FIG. 15 is a graph illustrating the impedance of the contact 160 in the coaxial connector device 101 according to the comparative example, where the horizontal axis indicates the position of the contact 160 and the vertical axis indicates the impedance. FIG. 16 is a graph illustrating the impedance of the contact 60 in the coaxial connector device 1 according to the first embodiment, where the horizontal axis indicates the position of the contact 60 and the vertical axis indicates the impedance. In FIGS. 15 and 16, a rising zone where the impedance rises as the contacts 160 and 60 come into contact with an airspace is shown by a dashed line. A falling zone where the impedance falls as the contacts 160 and 60 come into contact with an insulator is shown by a solid line.

As shown in FIG. 15, in the coaxial connector device 101 according to the comparative example, the tubular part 151 does not have the hole 53 through which the contact 160 is exposed. In this case, the distal end part 161a and the distal end part 162a come into contact with an airspace, and the other parts come into contact with an insulator. The contact 160 thus has three zones: the rising zone, the falling zone, and the rising zone, sequentially in the transmission path from the distal end part 161a to the distal end part 162a. In such a case, the impedance varies significantly among those zones. SI (Signal Integrity) characteristics are thereby degraded.

On the other hand, as shown in FIG. 16, in the coaxial connector device 1 according to the first embodiment, the tubular part 51 has the hole 53 through which the contact 60 is exposed. In this case, the distal end part 61a, the root part 61c, and the distal end part 62a come into contact with an airspace, and the other parts come into contact with an insulator. The contact 60 thus has five zones: the rising zone, the falling zone, the rising zone, the falling zone, and the rising zone, sequentially in the transmission path from the distal end part 61a to the distal end part 62a. In such a case, the impedance varies less significantly among those zones. SI (Signal Integrity) characteristics are thereby improved.

Although an embodiment of the present disclosure is described in the foregoing, the present disclosure involves appropriate modifications without impairment of its object and effects and is not restricted to the above-described embodiment. Further, the structures in the comparative example and the first embodiment may be appropriately combined.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A coaxial connector device comprising a contact unit, the contact unit comprising:
a contact; and
a housing that encloses a part of the contact,
wherein the contact unit is formed by insert molding.

2. The coaxial connector device according to claim 1, further comprising:
a die-cast member, wherein
the contact and the die-cast member each contain a conductor,
the housing contains an insulator, and
a part of the housing extending in an axial direction is disposed between a part of the contact extending in the axial direction and the die-cast member.

3. The coaxial connector device according to claim 2, further comprising:
an external housing containing the insulator; and
a shielding shell containing the conductor, wherein
the external housing includes:
a first body part having a first penetrating hole; and
a first mating part,
the die-cast member includes:
a second body part having a second penetrating hole configured to communicate with the first penetrating hole; and
a second mating part configured to mate with the first mating part, and
the shielding shell includes:
a third body part;
a spring member having a spring shape;
a cover part configured to cover the first mating part; and
a fitting part formed at an end of the cover part and configured to be fit into a recess of the first mating part.

4. The coaxial connector device according to claim 1, wherein the contact includes:
a distal end part projecting from the housing; and
a middle-root part connected to the distal end part,
wherein the housing has at least one hole where a part of the middle-root part is exposed.

5. The coaxial connector device according to claim 4, wherein
the housing has a plurality of holes, and
the plurality of holes are formed with the contact interposed therebetween.

6. The coaxial connector device according to claim 5, wherein
the middle-root part includes a part having a square bar shape, and
a part of each of opposed side surfaces is exposed through the plurality of holes.

7. The coaxial connector device according to claim 5, wherein
the middle-root part includes a part having a round bar shape, and
a part of each of opposed side surfaces is exposed through the plurality of holes.

8. The coaxial connector device according to claim 5, wherein the contact includes:
a first bar-shaped part including the distal end part and the middle-root part; and
a second bar-shaped part orthogonal to the first bar-shaped part.

9. A method of manufacturing a coaxial connector device for forming a contact unit including a contact and a housing that encloses a part of the contact by insert molding, the method comprising:
a step of preparing the contact;
a step of enclosing a part of the contact with an encapsulant; and
a step of curing the encapsulant and thereby forming the contact unit by insert molding.

10. The method of manufacturing a coaxial connector device according to claim 9, wherein the step of preparing the contact includes forming the contact by bending a bar-shaped member containing a conductor.

11. The method of manufacturing a coaxial connector device according to claim 9, wherein the step of preparing the contact includes forming the contact by cutting the contact out of a plate-shaped member containing a conductor.

12. The method of manufacturing a coaxial connector device according to claim 9, wherein
the step of enclosing a part of the contact with an encapsulant includes:
exposing a distal end part of the contact from the encapsulant; and
enclosing, with the encapsulant, a middle-root part connected to the distal end part and at least one holding member configured to come into contact with a part of the middle-root part so as to support the contact,
the step of insert molding includes removing the holding member, so that
the contact includes the distal end part projecting from the housing, and the middle-root part connected to the distal end part, and
the housing has at least one hole from which a part of the middle-root part is exposed.
